(19) United States
(12) Patent Application Publication
(10) Pub. No.: US 2004/0236686 A1
(43) Pub. Date: Nov. 25, 2004

(54) Method for billing for a communication service

(76) Inventors: Bernhard Bohmer, Berlin (DE); Georg Kastelewicz, Berlin (DE); Peter Kim, Berlin (DE); Jens Schendel, Berlin (DE)

Correspondence Address: MORRISON & FOERSTER LLP, 1650 TYSONS BOULEVARD, SUITE 300, MCLEAN, VA, 22102, US

(21) Appl. No.: 10/487,708

(22) PCT Filed: Aug. 23, 2002
(86) PCT No.: PCT/DE02/03159

(30) Foreign Application Priority Data
Aug. 27, 2001 (DE) 101 42 868.5

(51) Int. Cl. G06F 17/60

(52) U.S. Cl. 705/40

(57) ABSTRACT

The invention relates to a method for billing a communication service to be provided by a service network, whereby service user access to the service network is achieved by means of an access network connected to the service network. In order to be able to bill the communication services to be provided by such a service network in a simple and reliable manner a service usage request is assigned a code, the service usage request and the code are transmitted from the access network to the service network, a desired service corresponding to the service usage request is provided by the service network using the access network, at least one service-billing message, including the code is sent to a billing unit by the service network and the service billing messages and the access billing messages are recognized by means of the code occurring together with the service usage request and billed together.

### CLAIM FOR PRIORITY

This application claims priority to International Application No. PCT/DE02/03159, which was published in the German language on Mar. 27, 2003, which claims the benefit of priority to Germany Application No. DE 101 42 868.5 which was filed in the German language on Aug. 27, 2001.

### TECHNICAL FIELD OF THE INVENTION

The invention relates to a method for billing for a communication service which is to be organized by a service network, and in particular, where the service network is accessed at the service user end using an access network which is connected to the service network.

### BACKGROUND OF THE INVENTION

It is general knowledge, for example from third generation mobile radio networks (e.g. from UMTS networks), that a service network which organizes communication services for service users and also identifies these services is connected to the service users' communication terminals via an access network. The service network may be, by way of example, an IM domain or an IM subsystem for the UMTS communication network; the access network may be in the form of a GPRS network, for example.

### SUMMARY OF THE INVENTION

The invention discloses a method which provides a simple and reliable way of billing for communication services which are to be organized by such a service network.

In one embodiment of the invention, there is a method in which a service use request from a communication terminal connected to the access network is assigned an identifier, the access network transfers the service use request and the identifier to the service network, the service network organizes provision of a requested service corresponding to the service use request using the access network, the service network transfers at least one service billing message including the identifier to a billing unit in order to bill for the service, the access network transfers at least one access billing message including the identifier to the billing unit in order to bill for use of the access network, the billing unit identifies from the identifier the service billing messages and access billing messages which have arisen in connection with the service use request, and the billing unit bills for these service billing messages and access billing messages together. In this context, the billing unit advantageously bills for the service billing messages and the access billing messages together, so that a user of the communication terminal (service user) also receives one bill for his service use request, which makes settlement particularly simple for the service user.

In one aspect of the invention, the method can be in a form such that the service network is accessed at the service user end by virtue of the communication terminal registering with the access network and the latter prompting setup of at least one service-specific connection between the communication terminal and the service network, the service use request is transferred from the access network via the at least one connection to the service network, the identifier used is an identifier which is linked to the at least one connection, and the service is provided by using the at least one connection from the access network. In this context, it is particularly advantageous for the identifier used to be an identifier which is linked to the connection. This is because the data which arise in connection with the service use request and with the service provision are transported using the connection through the access network and can thus be connected to the requested service in a particularly simple manner.

The method can also be in a form such that the billing messages are each supplemented with an identifying feature of the communication terminal. A particular advantage is this context is that the billing unit is supplied directly with information about the communication terminal, so that the billing unit does not have to ascertain this information from the identifier and from the association between the identifier and the service use request, for example.

The method can also be in a form such that the billing unit bills for the billing messages at a time subsequent to provision of the service. This means that the method is advantageously suitable particularly for charging after service provision, “post paid charging”.

The method can also be carried out such that the service use request is transferred to the service network using a communication protocol called “Session Initiation Protocol”.

The method can also be in a form such that the identifier is transferred to the service network using a Go interface.

The method can also be in a form such that the service network organizes a service in a form of setup of a telephone connection between the communication terminal and a further communication terminal. This makes the inventive method particularly suitable for performing telephone services (e.g. audio telephony, video telephony) between two terminals.

The method can also be in a form such that the service network organizes a service in a form of a data transfer to the communication terminal. This means that the inventive method is also suitable for “content services”, that is to say services in which particular information contents are transmitted to a user.

The method can also be in a form such that the service billing messages and access billing messages are billed for together by virtue of an operator of the communication terminal being invoiced for a payment sum which includes payment sum components for service provision and payment sum components for use of the access network. In particular, this has the advantage that an operator (user) of the communication terminal is invoiced just one payment sum per service used, with this payment sum including payment sum components both for the service provision and for use of the access network. The payment sum can be split into the payment sum components at a later time by an operator of the billing unit; a contract can be taken as a basis for regulating how the payment sum is to be split between, by way of example, an operator of the service network and an operator of the access network.

In another embodiment of the invention, there is a method in which a service use request from a communication terminal connected to the access network is assigned an identifier by the access network, the access network transfers the service use request to the service network, a first detection node in the access network transfers an access network message including the identifier to a billing facility which manages a credit account associated with the communication terminal, the access network transfers the identifier to the service network, a second detection node in the service network transfers a service network message containing the identifier to the billing facility, the billing facility identifies from the identifier transferred with the access network message and with the service network message that the first and the second detection node are connected to the service provision request, the billing facility instructs one or more of the detection nodes to detect a-billing sum, the service network organizes provision of a requested service corresponding to the service use request using the access network, the instructed detection nodes detect billing sums, and the billing facility settles the detected billing sums using the credit account. A particular advantage in this context is that the billing facility is able to stipulate which of the detection nodes is/are instructed to detect the billing sum, so that the networks for which no billing is requested the billing can be stopped by virtue of their detection nodes not being instructed to detect a billing sum. The billing facility can thus “turn off”, so to speak, the billing for particular networks (for example for the access network).

In one aspect of the invention, the method can be in a form such that the service network is accessed at the service user end by virtue of the communication terminal registering with the access network and the latter setting up at least one service-specific connection between the communication terminal and the service network, the service use request is transferred from the access network via the at least one connection to the service network, the identifier used is an identifier which is linked to the at least one connection, and the service is provided by using the at least one connection from the access network.

In the case of the method in line with the application, the registration messages can also each be supplemented with an identifying feature of the communication terminal.

The method can also be in a form such that the instructed detection nodes detect the billing sums as an accompaniment to provision of the service. Advantageously, this allows the method to be applied for billing using credit accounts (“prepaid charging”), since such credit accounts requite the billing to be performed as soon as the service is provided.

The method can also be in a form such that the service use request is transferred to the service network using a communication protocol called “Session Initiation Protocol”.

The method can also be in a form such that the identifier is transferred to the service network using a Go interface.

In the case of the method, the service network can organize services in the form of setup of telephone connections between various communication terminals or else can organize services in a form of a data transfer to the service user communication terminal. This advantageously means that the inventive method is suitable for billing both for telephone services and “content services”.

The method can also be carried out such that the billing facility can dynamically change the instruction to the detection node(s) to detect the billing sum during provision of the service. An advantage in this case is that the type of billing can be changed during provision of a service, e.g. upon the occurrence of events or on a time-dependent basis.

### BRIEF DESCRIPTION OF THE DRAWINGS

A more detailed explanation of the invention is found below, with reference to the drawings, in which:

FIG. 1 shows an exemplary embodiment of a sequence for the inventive method with schematically shown communication networks.

FIG. 2 shows an exemplary embodiment of another sequence for the inventive method.

### DETAILED DESCRIPTION OF THE INVENTION

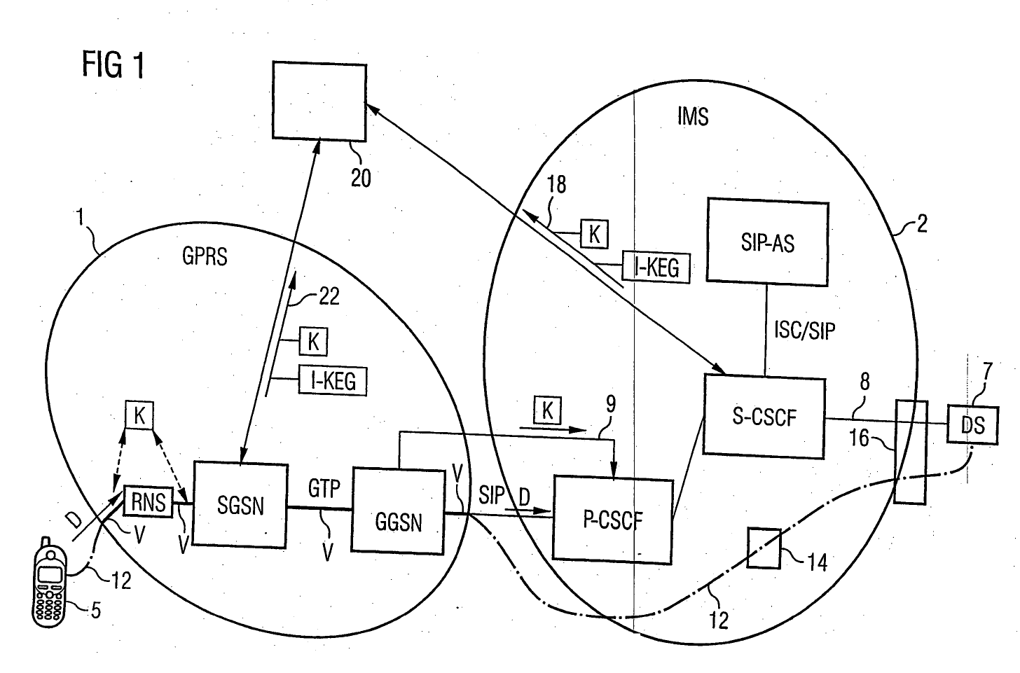

The left-hand part of FIG. 1 shows an access network 1, and the right-hand part of FIG. 1 shows a service network 2. In this context, an access network is intended to be understood to mean a communication network which provides a service user with the opportunity to gain access to a service network.

A service network is intended to be understood to mean a communication network which organizes or provides communication services for a service user. In this context, the service network provides “basic network services”, that is to say, by way of example, user authentication, mobility management, the assurance of a particular transfer quality (quality of service), charging services and interworking services (such as routing or roaming). The service network may likewise provide “end user services” such as information transfer services, “video on demand” services or games; alternatively, such end user services may be provided for the service user by another service provider connected to the service network. Examples of access networks are GPRS networks (GPRS=General Packet Radio Service), wireless LAN (LAN=Local Area Network) or cable networks. An example of a service network is the IM domain network (IM=IP Multimedia), which is also called an IMS network (IMS=IM Subsystem), used in third generation UMTS (UMTS=Universal Mobile Telecommunications Service) mobile radio networks.

In such a service network, it is possible to perform time-based charging, for example, that, is to say that communication connections are billed for on the basis of their length (for example in 10-second cycles). In access networks, it is possible to perform volume-based charge billing, for example, that is to say that the data transferred by the access network are billed for on the basis of their data volume (for example specified in megabytes).

If a communication terminal 5 is intended to be used to make use of a service from a service server 7 connected to the service network, then the communication terminal 5 sends a service use request D to the access network 1. (Instead of the service server 7, which may be associated with a content provider, for example, it is also possible for there to be another communication network subscriber, for example if the service involves conducting a video telephone call).

The service use request D may be, by way of example, an “SIP-Invite” message which has been set up on the basis of the SIP protocol (S IP=Session Initiation Protocol). The service use request D contains an address associated with the service, for example an SIP-URL (URL=Uniform Resource Locator) associated with the service or else a service telephone number. The access network has already set up a connection V (a “PDP-Context” (PDP=Packet Data Protocol)) between the communication terminal 5 and the service network 2 when the communication terminal logged on (registered). This connection V connects the communication terminal 5 to a connection node GGSN (GGSN=Gateway GPRS Support Node) via an exchange SGSN (SGSN=Serving GPRS Support Node) using a “Radio-Network System” RNS. This connection V is assigned a unique identification number (the “GPRS_Charging_ID). This number identifies the connection (the PDP-Context) uniquely with respect to the respectively used connection node GGSN. Together with an address for the connection node GGSN (“GGSN_Address”), the GPRS_Charging_ID thus forms a globally unique identifier K which is assigned to the connection V and to the service use request D transported via the connection V. (Identifier=combination of GPRS_Charging ID and GGSN_Address). The access network thus contains the information that the connection V is used to transmit data which belong to the service use request D from the communication terminal 5.

The service use request D is now transferred from the connection node GGSN in the access network 1 via an SIP interface to a reception node P-CSCF (P-CSCF=Proxy-Call Session Control Function). This reception node P-CSCF forwards the service use request to a control node S-CSCF (S-CSCF=Serving-Call Session Control Function). The control node S-CSCF then sets up an SIP connection 8 to the service server 7, so that there is now a continuous signaling connection between the communication terminal 5 and the service server 7. The service server 7 can now provide the requested service for the communication terminal 5, with the provision of this service being organized by the service network 2.

The connection node GGSN uses a further connection 9 to transfer the identifier K to the reception node P-CSCF in the service network 2. The connection 9 may have been provided using a “Go interface”, for example, as described in the printed document “3GPP TS 23.207” V5.0.0 (2001-06); Technical Specification; 3rd Generation Partnership Project; Technical Specification Group Services and System Aspects; End-to-End QoS Concept and Architecture; (Release 5), particularly on pages 15 to 17. The reception node P-CSCF transfers this identifier K to the control node S-CSCF. One way of doing this is for the reception node P-CSCF to add the identifier K to the service use request D and for the identifier K to be transferred to the control node S-CSCF together with the service use request D. Alternatively, it is possible for the identifier K to be transferred from the reception node P-CSCF to the control node S-CSCF using another message. The service network 2 (for example in the case of the control node S-CSC) now includes the information that the service use request D from the communication terminal 5 has an associated identifier K.

In order for the requested service to be provided by the service server 7, a user data connection 12 is now set up between the communication terminal 5 and the service server 7, the connection being illustrated by a dash-dot line. This user data connection 12 extends from the communication terminal 5 via the connection V in the access network 1 to the service network 2. After the connection node GGSN, the user data are transported by a different path, however, than the SIP messages used for signaling (e.g. the service use request). The figure shows how user data are able to arrive at the service server 7 or are able to arrive at the communication terminal 5 from the latter via different routers 14 and 16. The router 16 may be a firewall server, for example.

In this exemplary embodiment, the requested service is intended to involve the service server 7 transferring a video film to the communication terminal 5 via the user data connection 12. To bill for the service, the control node S-CSCF sends a service billing message 18 (a “charge ticket”) to a billing unit 20. Besides information about the service for which billing is necessary, the service billing message 18 includes the identifier K and an identifying feature I-KEG (e.g. its MSISDN) of the communication terminal 5. This service billing message 18 includes billing for the service comprising provision of the film by the service server 7 and also for user data transfer for the film from the service server 7 to the access network GPRS. The film user data are forwarded transparently from the access network 1 to the communication terminal 5. From the point of view of the access network, data transfer with a particular volume of data is taking place. In order to bill for this transport service by the access network, the exchange SGSN sends an access billing message 22, which likewise includes the identifier K and the identifying feature I-KEG of the communication terminal 5, to the billing unit 20. The access billing message 22 can also be a “charge ticket”. Besides the service billing message 18, the billing unit 20 also stores the access billing message 22. It is respectively possible for both the exchange SGSN and the control node S-CSCF to send a plurality of billing messages to the billing unit 20 in order to bill for a service. At a time after provision of the service, the billing unit 20 ascertains from all of the billing messages which it stores those billing messages which are related to the film delivery service for the communication terminal 5. This is done by virtue of the billing unit 20 ascertaining the billing messages which contain the identifier K. The billing unit 20 can now bill for the service billing message 18, the access billing message 22 and for any other billing messages which have arisen in connection with the service use request D, by combining billing information contained in these billing messages, determining a payment sum therefrom and invoicing this payment sum to an operator of the communication terminal 5. This payment sum then, includes payment sum components for the service of providing the film, of transferring the film from the service server 7 to the access network 1 and also the payment sum components for use of the access network 1 for transparently forwarding the film data to the communication terminal 5. This type of service billing is also called post paid billing, since the actual billing takes place after the service has been provided and thus generally after the communication connection between the communication terminal 5 and the service server 7 has been cleared down.

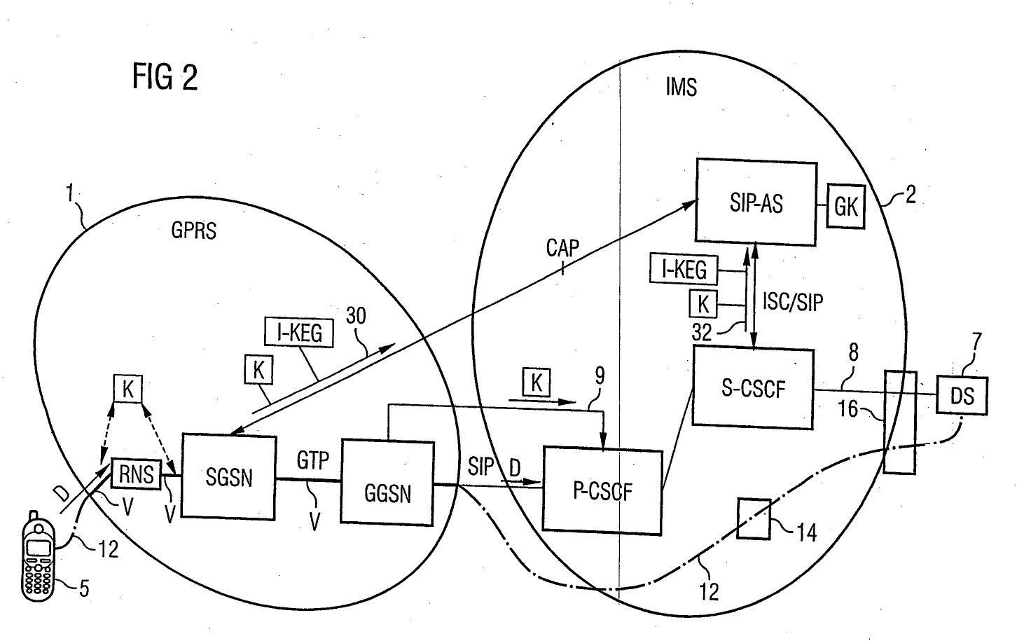

FIG. 2 is intended to give a more detailed explanation of another exemplary embodiment of the inventive method, in which “prepaid billing” for a requested service is carried out. The left-hand side of FIG. 2 again shows the access network 1 and the right-hand side shows the service network 2 from FIG. 1. Unlike in FIG. 1, however, the method which will now be described does not use a post paid billing unit 20 as shown in FIG. 1, but rather the service network 2 has a billing facility SIP-AS which is in the form of an SIP application server (SIP-AS=SIP Application Server). Such an SIP application server is also called a prepaid server and manages a prepaid credit account GK which is associated with the communication terminal 5. However, such an SIP application server is just one example of such a billing facility, and other implementations of prepaid servers may also be used, for example. In the case of prepaid billing, an operator of the communication terminal 5 pays a particular credit sum in advance into the credit account GK associated with the communication terminal 5 and, during provision of the service, that is to say while the communication connections have been set up between the communication terminal 5 and the service server 7 and, by way of example, data are being transferred from the service server 7 to the communication terminal 5, the credit account balance is reduced in line with the progress of the service, for example by debiting money, credit seconds or credit megabytes from the credit account.

In this exemplary embodiment, the start of the method in line with the application corresponds to the exemplary embodiment described in conjunction with FIG. 1. When the communication terminal 5 logs on, the connection V is thus set up between the communication terminal 5 and the service network 2. This connection and the service use request D are assigned the identifier K in a known manner, and the service use request D is routed in a known manner from the communication terminal 5 via the radio network system RNS to the exchange SGSN. The exchange SGSN now knows that a communication connection is to be set up from the communication terminal KEG. The exchange SGSN does not know for what sort of destination this communication connection is to be set up, since the connection V is used to forward the messages from the communication terminal 5 merely transparently, but they are not evaluated by the network elements of the access network 1. However, the access network 1 also knows that the connection V has the associated identifier K. The exchange SGSN in the access network 1 now sends an access network message 30, which may have been set up on the basis of the CAP standard (CAP=Camel Application Protocol) for example, to the billing facility SIP-AS in the service network 2. Such a message 30 is also called an “access charging message” With the access network message 30, the identifier K and an identifying feature I-KEG of the communication terminal 5 are transferred to the billing facility SIP-AS. (prepaid server). The prepaid server SIP-AS now knows that the communication terminal 5 which can be identified from the identifying feature I-KEG wishes to set up a call and that this call can be identified from the identifier K.

The service use request message D is then transferred in a known manner via the connection V, via the connection node GGSN to the reception node P-CSCF in the service network 2. The reception node P-CSCF now polls the access network 1 for the identifier K which is associated with the service use request D received from it. The connection node GGSN in the access network 1 uses the connection 9 to transfer the identifier K to the reception node P-CSCF. The reception node P-CSCF now adds this identifier to the service use request D, for example, and transfers the service use request message D together with the identifier to the control node S-CSCF. However, it is likewise possible for the reception node P-CSCF to transmit the identifier K to the control node S-CSCF using a separate message.

The control node S-CSCF now sends a service network message 32 to the billing facility SIP-AS, this service network message 32 containing the identifier K and the identifying feature I-KEG of the communication terminal KEG. Such a message 32 is also called a “content charging message” (or a “service charging message” if the service is video telephony, for example). As a result of the service network message 32, the billing facility SIP-AS receives the information that the communication terminal which can be identified from the identifying feature I-KEG wishes to use a specific service (in this case the film delivery service, for example) and that this service use request has the associated identifier K. Thus, the billing unit SIP-AS now has the information available regarding at which points or nodes in the access network (namely the SGSN) andiron the service network (namely the S-CSCF) billing sums which are intended to be settled using the credit account may arise during provision of precisely this film delivery service. The exchange SGSN can thus be referred to as a first detection node in the access network, which is able to detect billing sums arising in the access network and to forward them to the billing facility SIP-AS. The control node S-CSCF may also be referred to as a second detection node in the service network, which is able to detect billing sums arising in the service network and to forward them to the billing facility SIP-AS.

The prepaid server thus identifies that the first detection node and the second detection node are connected to the service provision request D and that these two nodes are able to collect data in order to charge (bill) for the service called up using the service provision request D.

For identification purposes, it thus suffices if the access network message 30 and service network message 32 transfer the identifier to the prepaid server so that the latter is able to assign the billing sums (charge requisitions) subsequently arriving on the two “channels” to a service which has been provided (a “session”).

If, in another example (not shown in FIG. 2), yet another network (for example another access network or another service network) is involved in the provision of service between the service server 7 and the communication terminal 5, then a third detection node provided in this further network will also send a message, of similar structure to the access network message or to the service network message 32, to the billing facility SIP-AS, whereupon the billing facility would know that there are three potential detection nodes at which billing sums may arise.

For the current film delivery service, the billing facility SIP-AS knows that, by way of example, only billing sums detected by the second detection node in the service network are to be debited from the credit account. This information may be stored in the billing facility SIP-AS, for example in a table, with the table listing for the available services which detection node is intended to detect billing sums for such a service and to supply them for consideration by the billing facility. By way of example, for the film delivery service provided by the service server 7, an entry in this table shows that billing sums from the service network 2 are considered, whereas the first detection node in the access network 1 does not need to detect billing sums and take them into account for settlement using the credit account.

In other words, charging by the access network needs to be “turned off” completely, while charging or billing by the service network is to take place. This can be implemented in various ways:

Example 1: If the prepaid charging is effected such that the billing facility (prepaid server) SIP-AS sends a particular portion of the credit available in the credit account to the detection node, the detection node continually monitors the consumption of these credit portions during service provision, and if appropriate new portions of the credit are requested by the billing facility, then a detection node operating in this manner can be instructed to detect a billing sum by virtue of a credit component. (to be more precise the information about a credit component) being transmitted to it. Referred to our example of application, this means that the billing facility SIP-AS sends information about a portion of the credit (for example in the form “credit for 2 minutes of film transfer”) to the control node S-CSCF. By contrast, the exchange SGSN is not allotted a portion of the credit. Subsequently, the control node S-CSCF and hence the service network 2 can detect billing sums, and only these billing sums are debited from the credit account, while charging or billing by the access network 1 is more or less “turned off” and no billing sums arise through the access network 1.

Example 2: It is likewise conceivable for the prepaid charging to work such that the detection nodes send messages to the billing facility SIP-AS in a similar manner to charge pulses during provision of the service, and the billing facility debits a particular sum from the credit in the credit account whenever such a charge pulse is received. In this case; the billing facility SIP-AS would consider only the “billing pulses” which are transferred from the control node S-CSCF to the billing facility, but not those billing pulses which come, from the exchange SGSN. Hence, in this case too, billing for billing sums by the access network 1 would be deactivated, and only the service network 2 is able to settle billing sums for the service which is currently to be provided.

The detection nodes are selected (“turned on and off”) in real time during provision of the service.

The user data for the film delivery service are transferred from the service server 7 to the communication terminal 5 during provision of the service, as described in connection with FIG. 1.

The communication services organized by the service network may be provided, by way of example, by a service server which is situated outside the service network 2 (like the service server 7 in FIGS. 1 and 2). In this case, the service network 2 is responsible for organizing the setup of a communication connection between the service server 7 and the communication terminal 5 and also for billing for the service. However, it is likewise possible for such a service-providing server to be situated directly in the service network, and hence for the service not only to be organized by the service network 2 but also to be provided by it. The service network can thus connect a service for a user or can also provide it.

An example of how the billing facility is able to change the instruction to the detection node(s) to detect the billing sum dynamically during provision of the service is shown by the following case: in the case of the film transfer service, the first minute of film is intended to be provided to the user at no cost. Hence, at the start of film transfer, none of the detection nodes are instructed to detect billing sums. Only when the first minute of film running time has elapsed is the second detection node S-CSCF, for example, then instructed to detect billing sums.

The text above has described a plurality of methods which, even in the case of services which are organized and provided using a plurality of communication networks, can be used to bill a communication terminal for these services such that a) by way of example, despite billing demands from a plurality of networks, only one billing sum is invoiced to the communication terminal KEG (this applies particularly to the post paid billing method), b) selected networks are able to bill for sums for the respective service, since the billing from the other networks is more or less turned off (one example of this is billing in the prepaid service, which has been explained in connection with, FIG. 2). Any contractually stipulated financial clearing (“interoperator clearing”) between the operators of the various communication networks can be effected at a later time. By way of example, it is possible for a communication network whose charging has been turned off for a particular service to receive financial clearing from the operator of a network which is receiving charges for the service.

The methods described make a significant contribution to the fact that, from the point of view of the customer (that is to say from the point of view of the communication terminal 5), billing for services can be made much simpler and easier to understand. In particular, the customer also receives just one billing item in his invoice from a communication network, e.g. for use of a single service, instead of a plurality of billing items from a plurality of communication networks, which means that it is also possible to save on billing or logging costs, for example.

The methods described can be applied, by way of example, to various types of billing or charging (“charging layers”): for “access charging”, “service charging” and “content charging”. Access charging denotes charging which is performed on the access network, e.g. the GPRS network. Service charging is applied, by way of example, in the IMS in order to charge for services such as video telephony. Content charging denotes charging for the sale of information, e.g. web pages or else goods of all kinds. The individual “charging levels” can be implemented by various network elements.

In the case of “content charging”, content servers can send their charge demands to the IMS, where they are sent via the path of the SIP message flow to the S-CSCF. From, there, the charge demands are then sent to the prepaid server and are supplemented with the identifier.

What is claimed is:

1. A method for billing for a communication service which is configured to be organized by a service network, where the service network is accessed at a service user end using an access network which is connected to the service network, comprising:
assigning an identifier to a service use request from a communication terminal connected to the access network;
transferring the service use requests and the identifier to the service network;
organizing for a requested service corresponding to the service use request to be provided using the access network;
transferring at least one service billing message including the identifier to a billing unit to bill for the service;
transferring at least one access billing message including the identifier to the billing unit to bill for use of the access network;
identifying from the identifier the service billing messages and access billing messages which have arisen in conjunction with the service use request; and
billing for the service billing messages and access billing messages.

2. The method as claimed in claim 1, wherein
the service network is accessed at the service user end by a communication terminal registering with the access network and the access network prompting setup of at least one service-specific connection between the communication terminal and the service network,
the service use request is transferred from the access network via the at least one connection to the service network,
the identifier used is an identifier which is linked to the at least one connection, and
the service is provided by using the at least one connection from the access network.

3. The method as claimed in claim 2, wherein
the billing messages are each supplemented with an identifying feature of the communication terminal.

4. The method as claimed in claim 1, wherein
the billing unit bills for the billing messages at a time subsequent to provision of the service.

5. The method as claimed in claim 1, wherein
the service use request is transferred to the service network using a communication protocol called “Session Initiation Protocol”.

6. The method as claimed in claim 1, wherein
the identifier is transferred to the service network using a Go interface.

7. The method as claimed in claim 2, wherein
the service network organizes a service in form of setup of a telephone connection between the communication terminal and a further communication terminal.

8. The method as claimed in claim 2, wherein
the service network organizes a service in form of a data transfer to the communication terminal.

9. The method as claimed in claim 2, wherein
the service billing messages and access billing messages are billed by an operator of the communication terminal being invoiced for a payment sum which includes payment sum components for service provision and payment sum components for use of the access network.

10. A method for billing for a communication service which is configured to be organized by a service network, where the service network is accessed at the service user end using an access network which is connected to the service network, comprising:
assigning an identifier to a service use request from a communication terminal connected to the access network by the access network;
transferring the service use request to the service network;
transferring, via a first detection node in the access network, an access network message including the identifier to a billing facility which manages a credit account associated with the communication terminal;
transferring the identifier to the service network;
transferring, via a second detection node in the service network, a service network message including the identifier to the billing facility;
identifying from the identifier transferred with the access network message and with the service network message that the first and the second detection nodes are connected to the service provision request;
instructing one or more of the detection nodes to detect a billing sum;
organizing provision of a requested service, corresponding to the service use request, using the access network;
detecting billing sums via the instructed detection nodes; and
settling the detected billing sums using the credit account.

11. The method as claimed in claim 10, wherein
the service network is accessed at the service user end by the communication terminal registering with the access network and the access network setting up at least one service-specific connection between the communication terminal and the service network;
transferring the service use request from the access network via the at least one connection to the service network;
linking the identifier used to the at least one connection; and
providing the service by using the at least one connection from the access network.

12. The method as claimed in claim 10, wherein
the access network message and the service network message are each supplemented with an identifying feature of the communication terminal.

13. The method as claimed in claim 10, wherein
the instructed detection nodes detect the billing sums as an accompaniment to provision of the service.

14. The method as claimed in claim 10, wherein
the service use requests is transferred to the service network using a communication protocol called “Session Initiation Protocol”.

15. The method as claimed in claim 10, wherein
the identifier is transferred to the service network using a Go interface.

16. The method as claimed in claim 10, wherein
the service network organizes a service in form of provision of a telephone connection between the communication terminal and a further communication terminal.

17. The method as claimed in claim 10, wherein
the service network organizes a service in form of a data transfer to the communication terminal.

18. The method as claimed in claim 10, wherein
the billing facility dynamically changes the instruction to the detection node to detect the billing sum during provision of the service.
